(19) United States
(12) Patent Application Publication
(10) Pub. No.: US 2014/0022859 A1
(43) Pub. Date: Jan. 23, 2014

(54) IN-TANK PROPELLANT MIXING

(71) Applicant: FIRESTAR ENGINEERING, LLC, (US)

(72) Inventor: Gregory S. Mungas, Mojave, CA (US)

(73) Assignee: FIRESTAR ENGINEERING, LLC, Mojave, CA (US)

(21) Appl. No.: 13/753,798

(22) Filed: Jan. 30, 2013

Related U.S. Application Data
(60) Provisional application No. 61/592,120, filed on Jan. 30, 2012.

(51) Int. Cl. B01F 15/02

(52) U.S. Cl. CPC B01F 15/0227
USPC 366/182.3; 366/150.1; 366/182.1

(57) ABSTRACT

Separate pressure vessels for oxidizer and fuel components in a combustion/decomposition system add weight and complexity to the system. The fuel and oxidizer can be pre-mixed within a single pressure vessel, but can be unacceptably volatile in a mixed configuration. Providing separate fuel and oxidizer compartments within a singular pressure vessel reduces the weight and complexity of the system, while maintaining the non-volatility of separately stored fuel and oxidizer. The fuel and oxidizer can be selectively mixed within the pressure vessel when desired.

### CROSS-REFERENCE TO RELATED APPLICATIONS

The present application claims benefit of priority to U.S. Provisional Patent Application No. 61/592,120, entitled “In-Tank Propellant Mixing” and filed on 30 Jan. 2012, which is specifically incorporated by reference herein for all that it discloses or teaches.

### BACKGROUND

Thruster or rocket engines utilize decomposition and/or combustion of stored fuel and oxidizer to produce thrust. Other types of engines or gas generators also utilize a chemical reaction of stored fuel and oxidizer to produce other types of work or generation of gas. The fuel and oxidizer may be stored separately and combined immediately prior to combustion (e.g., a bipropellant) or premixed and stored prior to combustion (e.g., a monopropellant). For further details regarding monopropellants, see U.S. Pat. Pub. No. 2009/0133788 to Mungas et al. Separately, the fuel and oxidizer may be handled with a low risk of explosion. However, the combined fuel and oxidizer can be much more dangerous to handle and may explode spontaneously if sufficient activation energy is added to the mixed propellant. For example, a mixed propellant may be ignited if the storage tank is impacted, punctured by a projectile, and/or heated in a manner that adds sufficient energy to ignite the mixed propellant.

While fuel and oxidizer are more dangerous to handle when mixed, using separate pressure vessels to store the fuel and the oxidizer separately add expense and weight to a vehicle carrying the separate storage tanks. More specifically, two separate smaller pressure vessels, one storing a fuel and the other storing an oxidizer, with associated equipment may be more expensive and/or heavier than one large pressure vessel storing the same quantity of mixed fuel and oxidizer.

### SUMMARY

Implementations described and claimed herein address the foregoing problems by providing a pressure vessel comprising an oxidizer compartment, a fuel compartment, and a mixing trigger that selectively triggers mixing of oxidizer from the oxidizer compartment with fuel from the fuel compartment within the pressure vessel.

Implementations described and claimed herein address the foregoing problems by further providing a method comprising providing a pressure vessel with a fuel compartment and an oxidizer compartment and selectively mixing oxidizer from the oxidizer compartment with fuel from the fuel compartment within the pressure vessel.

Implementations described and claimed herein address the foregoing problems by still further providing a method comprising selectively mixing fuel with oxidizer within a pressure vessel, discharging the mixed fuel and oxidizer from the pressure vessel, and exothermically reacting the mixed and discharged fuel and oxidizer.

Other implementations are also described and recited herein.

### BRIEF DESCRIPTIONS OF THE DRAWINGS

FIG. 1 is a cross-sectional perspective view of an example vessel utilizing an in-tank propellant mixing system.

FIG. 2 is a cross-sectional elevation view of an example in-tank propellant mixing system with an internal single-discharge fuel tank releasing fuel into an encompassing oxidizer tank.

FIG. 3 is a cross-sectional elevation view of an example in-tank propellant mixing system with an internal multi-discharge fuel tank releasing fuel into an encompassing oxidizer tank.

FIG. 4 is a cross-sectional elevation view of an example in-tank propellant mixing system with a burst-disk fuel tank releasing fuel into an encompassing oxidizer tank.

FIG. 5 is a cross-sectional elevation view of an example in-tank propellant mixing system with a cylindrical fuel tank releasing fuel into an encompassing oxidizer tank.

FIG. 6 is a cross-sectional elevation view of an example in-tank propellant mixing system with a ruptured barrier releasing stored fuel into stored oxidizer within a tank.

FIG. 7 illustrates example operations for using an in-tank propellant mixing system according to the presently disclosed technology.

### DETAILED DESCRIPTIONS

Disclosed herein is a system and method of separately storing a fuel and an oxidizer within one pressure vessel (or tank) to decrease the weight and expense requirements of providing and maintaining two separate pressure vessels while maintaining the safety benefit of separately storing fuel and oxidizer.

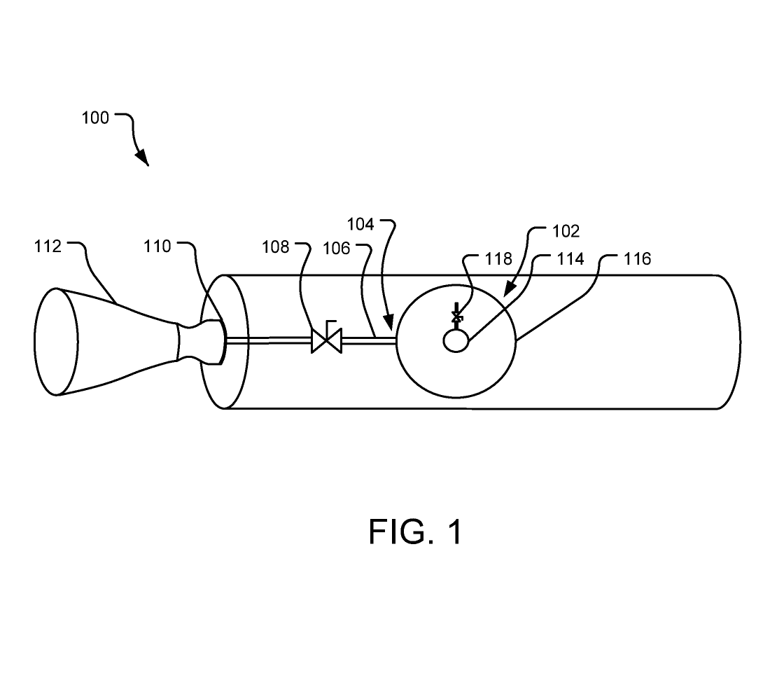

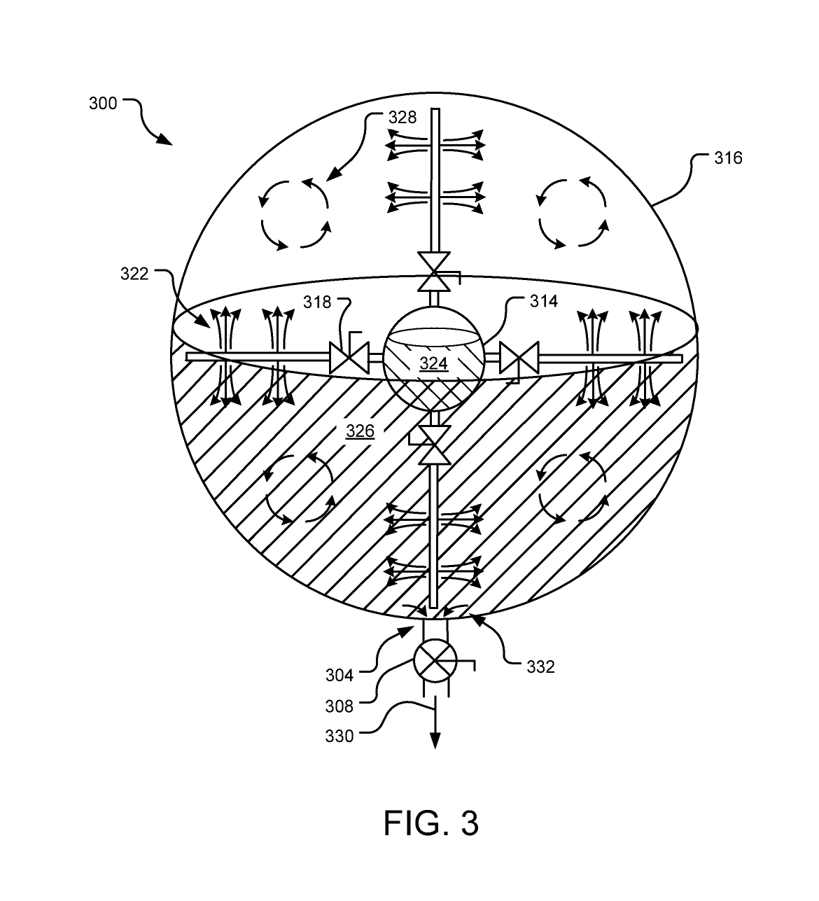

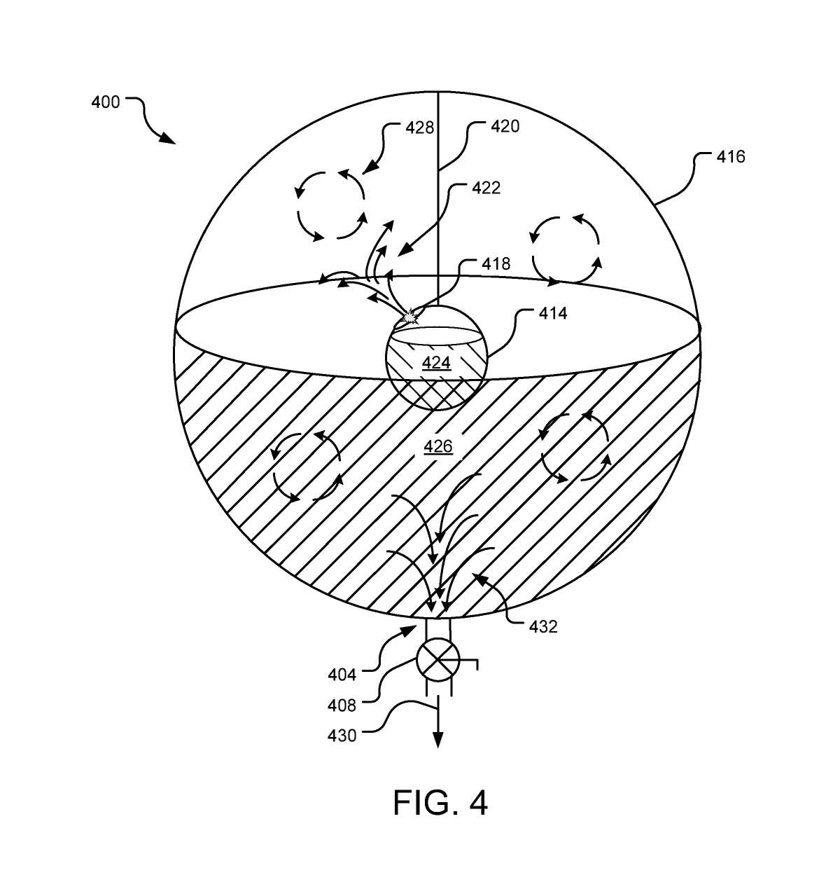

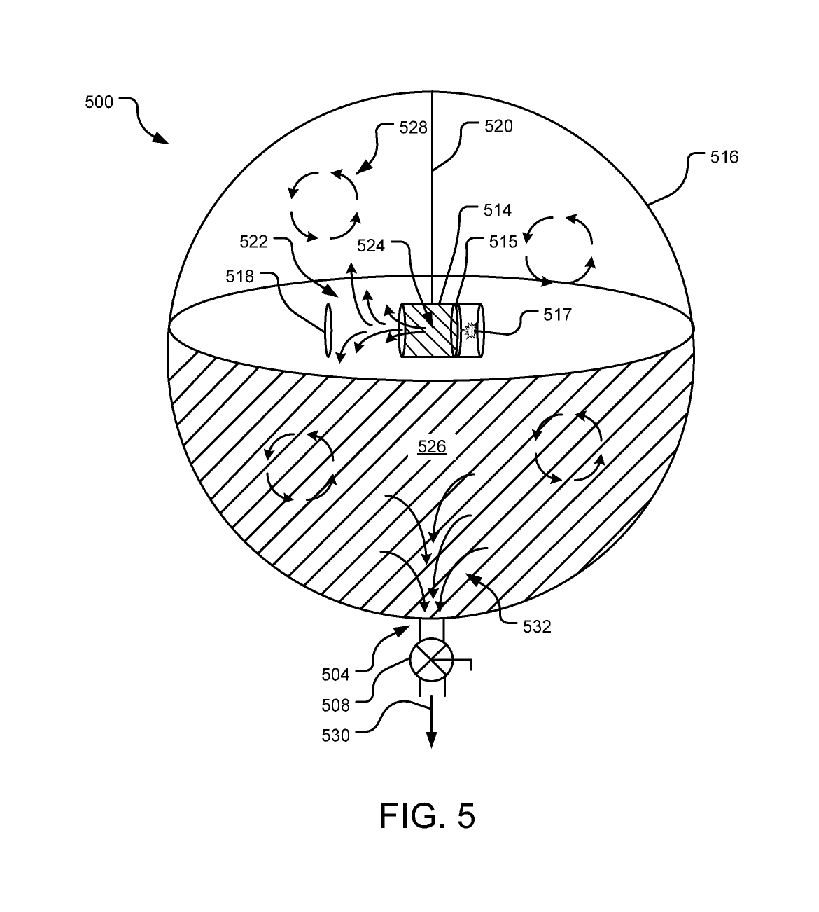

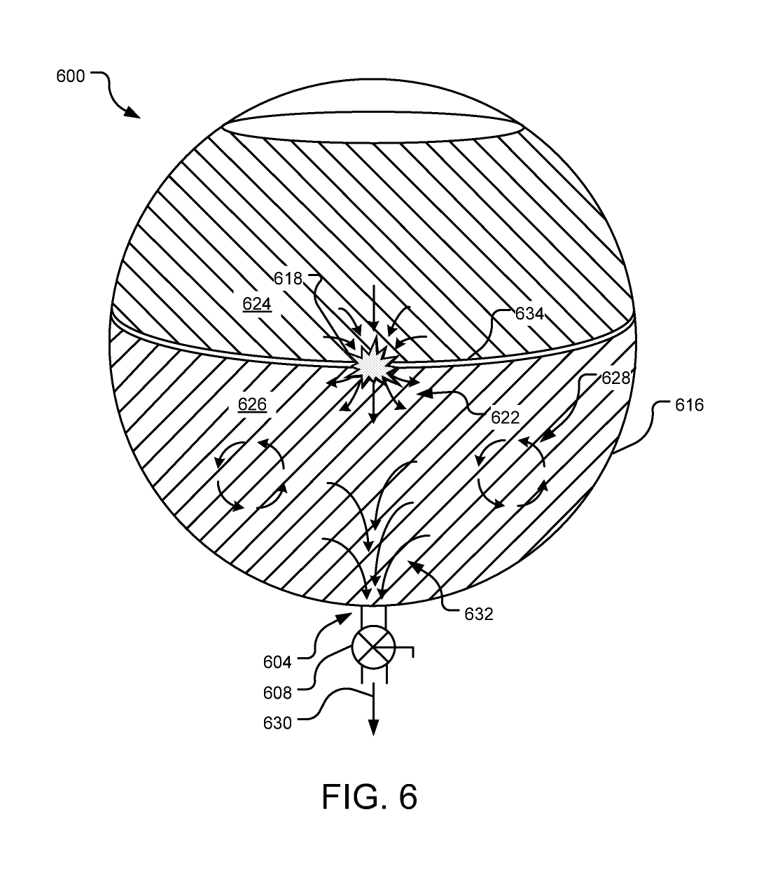

FIG. 1 is a cross-sectional perspective view of an example vessel 100 utilizing an in-tank propellant mixing system 102. The vessel 100 could be a rocket, thruster, or other engine that converts decomposition and/or combustion of propellant into thrust or work. The mixing system 102 includes a fuel storage tank 114 within an oxidizer storage tank 116. A valve 118 is actuated to release the stored fuel into the oxidizer storage tank 116 when a mixed fuel/oxidizer is desired. In other implementations, a mixing trigger other than the valve 118 (e.g., the multiple valves of FIG. 3, the burst disk 418 of FIG. 4, the explosive charge 517/piston 515/cap 518 combination of FIG. 5, and/or the puncturing device or explosive change 618 and barrier 634 of FIG. 6). In yet another implementation, all or a portion of the fuel storage tank 114 is dissolvable over time by the fuel and/or the oxidizer. The dissolving fuel tank wall(s) is the mixing trigger. Further, the dissolvable portion of the fuel storage tank 114 may be located within the oxidizer storage tank 116 such that it is partially or fully submerged in oxidizer to facilitate dissolving of the fuel storage tank 114.

The mixed fuel/oxidizer (i.e., propellant) is discharged from the tank 116 via an outlet 104 into lines 106. One or more valves (e.g., valve 108) and other equipment may also be located at the discharge of the tank 116. The lines 106 lead to an ignition interface 110 where the propellant is ignited and propelled out of an expansion nozzle 112. Due to conservation of momentum, the discharge of the combusted propellant out of the nozzle 112 from right to left causes the vessel 100 to be propelled from left to right in FIG. 1. In one implementation, the vessel 100 is a part of a larger vessel (e.g., vessel 100 is a thruster on a space station).

In an example implementation, the vessel 100 could be first located near a large quantity of people (e.g., in a city) or in a high-risk area (e.g., a combat zone). The fuel and oxidizer are stored in separate tanks 114, 116, respectively, to minimize the risk of explosion. An explosion could cause injury to the nearby population and/or destruction of the vessel 100 should energy sufficient to ignite mixed propellant be inadvertently applied to the tank 116. Once the vessel 100 is relocated away from the people or high-risk area (e.g., in lower Earth orbit after a successful launch of the vessel 100), the fuel and oxidizer stored in the tanks 114, 116, respectively, may be mixed so that the combined propellant may be combusted and/or decomposed to extract thrust or work from the vessel 100.

In one implementation, the fuel and the oxidizer are each stored at vapor pressure in the tanks 114, 116 respectively, with quantities of both gaseous-phase and liquid-phase oxidizer in the oxidizer tank 116 and quantities of both gaseous-phase and liquid-phase fuel in the fuel tank 114. In other implementations, the vapor pressures of the fuel in the fuel tank 114 and oxidizer in the oxidizer tank 116 differ sufficiently to create an all gaseous-phase or all liquid-phase fluid in one or both of the tanks 114, 116.

In an implementation where both the oxidizer and the fuel are relatively high vapor pressure fluids (e.g., typically significantly greater than 101 kPa at 25° C.). The storage tank 114 can be designed to withstand a relatively small differential pressure between the two stored fluids rather than a much larger pressure differential between the vapor pressure of the oxidizer in the oxidizer tank 116 and an external environment (e.g., underwater, atmosphere, space, and other external environments) ambient pressure. As a result, the storage tank 114 may be designed lighter and cheaper than the storage tank 116, which may store the oxidizer at a higher pressure relative to the outside of storage tank 116. For example, the storage tank 114 may merely be a bladder within a rigid storage tank 116.

In another implementation, the vapor pressure of the fuel may be significantly higher than the vapor pressure of the oxidizer (or vice versa), which facilitates rapid mixing of the fuel with the oxidizer when the valve 118 is opened. More specifically, the higher-pressure fuel is forced out of the storage tank 114 into the lower-pressure oxidizer within the storage tank 116 when the valve 118 is opened. The higher-pressure fuel continues to exhaust into the storage tank 116 until the pressure equalizes between the storage tanks 114, 116. In a further implementation, a relatively long period of time is available to mix the oxidizer and fuel. Even if the vapor pressures of the oxidizer and fuel are the same or nearly the same, mixing of the oxidizer and fuel through diffusion and/or convective fluid motion will occur over time. In another implementation, one or more areas of the storage tanks 114, 116 may be heated with sufficient energy to initiate and sustain convective currents within the storage tanks 114, 116 to facilitate mixing of the fuel and oxidizer, but insufficient energy to initiate a chemical reaction between the fuel and oxidizer.

The in-tank propellant mixing system 102 may work with a variety of oxidizers and fuels, each with a variety of vapor pressures (e.g., nitrous oxide, various hydrocarbon fuels, ammonia, oxygen, nitrogen tetroxide, nitric oxide, and methane). In some implementations, two or more smaller tanks are stored within a larger tank in systems that mix three or more individual component fuels/oxidizers. Further, while the storage tanks 114, 116 are both depicted as spherical, the storage tanks 114, 116 may be of any size and shape. Still further, storage tank 114 may be a flexible bladder. Further yet, while fuel storage tank 114 is depicted inside of the oxidizer storage tank 116, the oxidizer storage tank 116 may be inside of the fuel storage tank 114 depending on the desired mixing ratio of fuel to oxidizer. In various implementations, the desired volumetric ratio may vary from 1% to 50% fuel. Still further, multiple fuel storage tanks may be oriented inside of the oxidizer storage tank 116, or vice versa. Further yet, the storage tanks 114, 116 may store two separate working fluids other than an oxidizer and a fuel (e.g., two fuels, two oxidizers, a fuel and a non-oxidizer additive, an oxidizer and a non-fuel additive, or two non-oxidizer, non-fuel working fluids). In one implementation, the two separate working fluids form a monopropellant when mixed. In another implementation, the two separate working fluids form a non-energetic working fluid when mixed.

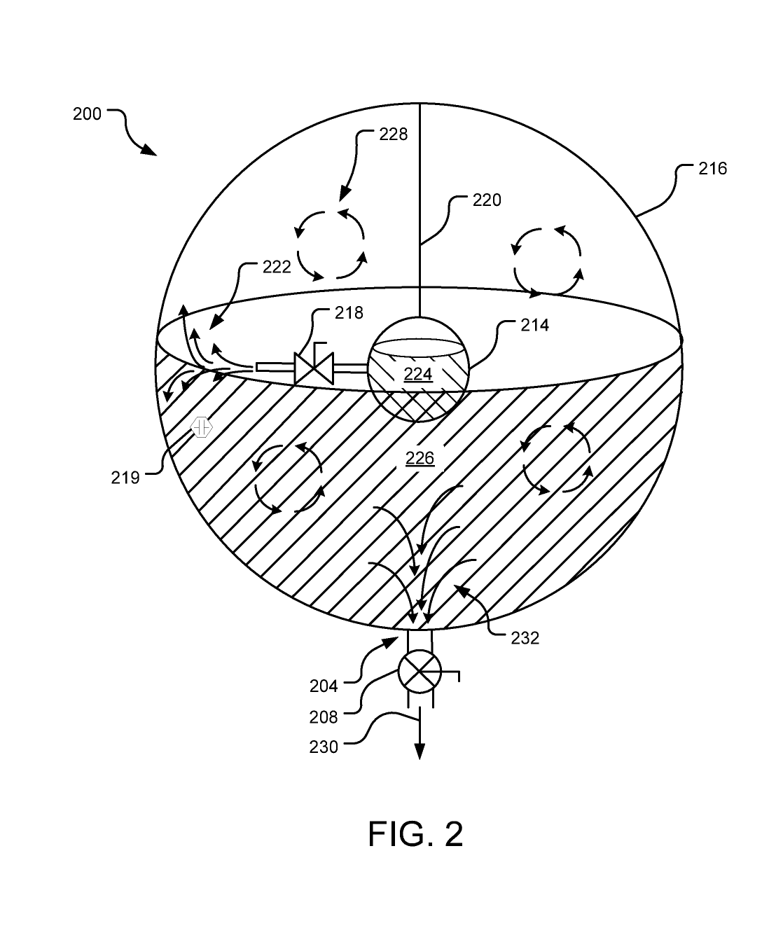

FIG. 2 is a cross-sectional elevation view of an example in-tank propellant mixing system 200 with an internal single-discharge fuel tank 214 releasing fuel 224 into an encompassing oxidizer tank 216. The fuel tank 214 is suspended or otherwise secured within the oxidizer tank 216 using one or more supports (e.g., support 220). In other implementations, the fuel tank 214 is not suspended within the oxidizer tank 216 and is allowed to move freely within the oxidizer tank 216. The oxidizer tank 216 acts a pressure vessel for both oxidizer 226 and the fuel 224 stored within the fuel tank 214.

The fuel tank 214 is equipped with a release mechanism (e.g., a valve 218) that when actuated releases the fuel 224 into the oxidizer tank 216 as illustrated by arrows 222. In other implementations, the release mechanism ruptures the fuel tank 214 to release the fuel 224 into the oxidizer tank 216 (see e.g., FIGS. 4 and 5). The released fuel 224 mixes with the oxidizer 226 stored within the oxidizer tank 216. Further, any movement of the released fuel 224 and/or oxidizer 226 causes an increased rate of mixing, as illustrated by circulation arrows (e.g., arrows 228). In one implementation, a separate mixing mechanism (e.g., a vortex generator, vanes adjacent outlet 204, etc. (not shown)) is used to induce movement of the fuel 224 and the oxidizer 226 and facilitate convective and/or diffusive mixing.

In one implementation, a mixing monitor 219 is incorporated within the oxidizer tank 216. The mixing monitor 219 includes any sensing and signaling device that is capable of monitoring for the release of the fuel 224 into the oxidizer 226 and alerting a user if and when the fuel 224 is released into the oxidizer 226. For example, the mixing monitor 219 may monitor for an unintentional or unexpected release of fuel 224 into oxidizer 226 (e.g., if the valve 218 leaks or unexpectedly fails). The mixing monitor 219 may alert the user to an unintentional or unexpected release by sounding visual and/or audio alerts, in some implementations through a computerized monitoring interface.

In one implementation, the mixing monitor 219 monitors for a minor pressure change when the fuel 224 is released into the oxidizer 226. In another implementation, the mixing monitor 219 includes a chemical or infrared sensor that detects the presence of the fuel 224. If the mixing monitor 219 is located in the oxidizer tank 216, as soon as the fuel 224 is released into the oxidizer 226, the mixing monitor 219 is triggered. In other implementations, the mixing monitor 219 is located in the fuel tank 214 and includes a chemical or infrared sensor that detects the presence of the oxidizer 226 in the fuel tank 214.

Once the fuel 224 and the oxidizer 226 are adequately mixed into a single propellant, the propellant may be discharged from the oxidizer tank 216 via the outlet 204 (as illustrated by arrows 232) with a control valve 208 that leads to a gas generator, a work-generating engine, or a device for generating thrust (not shown). In an example implementation utilizing an engine, the mixed propellant flows from the outlet 204 of the oxidizer tank 216, through the valve 208 (as illustrated by arrow 230), and into the engine, where work is extracted from the propellant. The control valve 208 may vary the flow rate of the propellant out of the oxidizer tank 216 to provide a desired work output from the engine. In other implementations, the control valve 208 is used to provide a desired gas generation rate or a desired level of thrust from a thruster. In other implementations, the storage tanks 214, 216 store two separate working fluids other than the fuel 224 and the oxidizer 226, which when combined may or may not produce a monopropellant.

FIG. 3 is a cross-sectional elevation view of an example in-tank propellant mixing system 300 with an internal multi-discharge fuel tank 314 releasing fuel 324 into an encompassing oxidizer tank 316. The fuel tank 314 is suspended or otherwise secured within the oxidizer tank 316 using one or more supports (not shown). In other implementations, the fuel tank 314 is not suspended within the oxidizer tank 316 and is allowed to move freely within the oxidizer tank 316. The oxidizer tank 316 acts a pressure vessel for both oxidizer 326 and the fuel 324 stored within the fuel tank 314.

The fuel tank 314 is equipped with one or more release mechanisms (e.g., valve 318) that when actuated release the fuel 324 into the oxidizer tank 316 (e.g., as illustrated by arrows 322). The multi-discharge system 300 of FIG. 3 may be significantly more efficient at mixing than the single discharge system 200 of FIG. 2 due to the multiple outlets from the fuel tank 314. The multiple discharges release the fuel 324 into the oxidizer tank 316 at multiple locations throughout the tank 316, expediting release of the fuel 324 and mixing throughout the oxidizer tank 316. The number of fuel discharges, shape and orientation of the manifold for releasing the fuel 324 into the oxidizer tank 316, and number of valves controlling the release of the fuel 324 may vary significantly depending on time constraints on how fast the fuel 324 and oxidizer 326 should mix and be ready to be discharged as a single propellant and cost and weight constraints for the system 300, for example. Further, the manifold may also serve as support for the fuel tank 314 within the oxidizer tank 316. Any movement of the released fuel 324 and/or oxidizer 326 causes an increased rate of mixing, as illustrated by circulation arrows (e.g., arrows 328). In one implementation, a separate mechanism (not shown) is used to induce movement of the fuel 324 and oxidizer 326 and facilitate mixing.

Once the fuel 324 and the oxidizer 326 are adequately mixed as a single propellant, the propellant may be discharged from the oxidizer tank 316 via an outlet 304 (as illustrated by arrows 332) with a control valve 308 that leads to a gas generator, a work-generating engine, or a device for generating thrust (not shown). In an example implementation utilizing an engine, the propellant flows from the outlet 304 of the oxidizer tank 316, through the valve 308 (as illustrated by arrow 330), and into the engine, where work is extracted from the propellant. The control valve 308 may vary the flow rate of the propellant out of the fuel tank 316 to provide a desired work output from the engine. In other implementations, the control valve 308 is used to provide a desired gas generation rate or a desired level of thrust from a thruster. In other implementations, the storage tanks 314, 316 store two separate working fluids other than the fuel 324 and the oxidizer 326, which when combined may or may not produce a monopropellant.

FIG. 4 is a cross-sectional elevation view of an example in-tank propellant mixing system 400 with a burst-disk fuel tank 414 releasing fuel 424 into an encompassing oxidizer tank 416. The fuel tank 414 is suspended or otherwise secured within the oxidizer tank 416 using one or more supports (e.g., support 420). In other implementations, the fuel tank 414 is not suspended within the oxidizer tank 416 and is allowed to move freely within the oxidizer tank 416. The oxidizer tank 416 acts a pressure vessel for both oxidizer 426 and the fuel 424 stored within the fuel tank 414.

The fuel tank 414 is equipped with a burst disk 418 that when ruptured releases the fuel 424 into the oxidizer tank 416 as illustrated by arrows 422. In one implementation, a puncturing device (not shown) is used to selectively rupture the burst disk 418. In another implementation, an explosive change is selectively detonated to release sufficient energy to rupture the burst disk 418 but insufficient energy to ignite the oxidizer 426 and fuel 424. Other systems and methods for rupturing the burst disk 418 without igniting the oxidizer 426 and the fuel 424 are contemplated herein.

The released fuel 424 mixes with the oxidizer 426 stored within the oxidizer tank 416. Further, any movement of the released fuel 424 and/or oxidizer 426 causes an increased rate of mixing, as illustrated by circulation arrows (e.g., arrows 428). In one implementation, a separate mechanism (not shown) is used to induce movement of the fuel 424 and the oxidizer 426 and facilitate convective and/or diffusive mixing.

Once the fuel 424 and the oxidizer 426 are adequately mixed into a single propellant, the propellant may be discharged from the oxidizer tank 416 via an outlet 404 (as illustrated by arrows 432) with a control valve 408 that leads to a gas generator, a work-generating engine, or a device for generating thrust (not shown). In an example implementation utilizing an engine, the mixed propellant flows from the outlet 404 of the oxidizer tank 416, through the valve 408 (as illustrated by arrow 430), and into the engine, where work is extracted from the propellant. The control valve 408 may vary the flow rate of the propellant out of the oxidizer tank 416 to provide a desired work output from the engine. In other implementations, the control valve 408 is used to provide a desired gas generation rate or a desired level of thrust from a thruster. In other implementations, the storage tanks 414, 416 store two separate working fluids other than the fuel 424 and the oxidizer 426, which when combined may or may not produce a monopropellant.

FIG. 5 is a cross-sectional elevation view of an example in-tank propellant mixing system 500 with a cylindrical fuel tank 514 releasing fuel 524 into an encompassing oxidizer tank 516. The fuel tank 514 is suspended or otherwise secured within the oxidizer tank 516 using one or more supports (e.g., support 520). In other implementations, the fuel tank 514 is secured to an interior surface of the oxidizer tank 516 within the use of one or more supports (i.e., the fuel tank 514 is directly attached to the interior surface of the oxidizer tank 516). In other implementations, the fuel tank 514 is not suspended within the oxidizer tank 516 and is allowed to move freely within the oxidizer tank 516. The oxidizer tank 516 acts a pressure vessel for both oxidizer 526 and the fuel 524 stored within the fuel tank 514.

The fuel tank 514 is equipped with a piston 515 that separates the fuel 524 within the fuel tank 514 from an explosive charge 517. Further, the fuel 524 within the fuel tank 514 may be separated from oxidizer 526 within the oxidizer tank 516 by a cap 518. In other implementations, the fuel 524 may be separated from oxidizer 526 by a burst disk, or membrane, for example. The explosive charge 517 may be a liquid or solid propellant, which when detonated releases sufficient energy to rupture and/or remove the cap 518 and move the piston 515 outward, forcing the fuel 524 out of the fuel tank 514, as illustrated by arrows 522. However, the explosive charge 517 releases insufficient energy to ignite the mixing oxidizer 526 and fuel 524. In another implementation, a puncturing device (not shown) is used to selectively rupture the cap 518. Further, use of a solid or liquid propellant to forcibly discharge the fuel 514 from the fuel tank 514 into the oxidizer tank 516 is contemplated herein.

In some implementations, the explosive charge 517 may be replaced with a high-pressure gas or liquid. Further, the piston 515 may be selectively ruptured and/or removed. In such a case, a puncturing device (not shown) is used to selectively rupture the piston 515 separating the high-pressure gas or liquid from the fuel 514, which sufficiently pressurizes the fuel 524 to rupture and/or remove the cap 518 from the tank 514 and discharge the fuel 524 into the oxidizer 526.

The released fuel 524 mixes with the oxidizer 526 stored within the oxidizer tank 516. Further, any movement of the released fuel 524 and/or oxidizer 526 causes an increased rate of mixing, as illustrated by circulation arrows (e.g., arrows 528). In one implementation, a separate mechanism (not shown) is used to induce movement of the fuel 524 and the oxidizer 526 and facilitate convective and/or diffusive mixing.

Once the fuel 524 and the oxidizer 526 are adequately mixed into a single propellant, the propellant may be discharged from the oxidizer tank 516 via an outlet 504 (as illustrated by arrows 532) with a control valve 508 that leads to a gas generator, a work-generating engine, or a device for generating thrust (not shown). In an example implementation utilizing an engine, the mixed propellant flows from the outlet 504 of the oxidizer tank 516, through the valve 508 (as illustrated by arrow 530), and into the engine, where work is extracted from the propellant. The control valve 508 may vary the flow rate of the propellant out of the oxidizer tank 516 to provide a desired work output from the engine. In other implementations, the control valve 508 is used to provide a desired gas generation rate or a desired level of thrust from a thruster. In other implementations, the storage tanks 514, 516 store two separate working fluids other than the fuel 524 and the oxidizer 526, which when combined may or may not produce a monopropellant.

FIG. 6 is a cross-sectional elevation view of an example in-tank propellant mixing system 600 with a ruptured barrier 634 releasing stored fuel 624 into stored oxidizer 626 within a storage tank 616. The storage tank 616 has separated sections storing fuel 624 and oxidizer 626. The storage tank 616 acts a pressure vessel for both the fuel 624 and the oxidizer 626, while the barrier 634 merely separates the fuel 624 from the oxidizer 626. In one implementation, the barrier 634 is a thin flexible non-permeable membrane that is designed to withstand an expected pressure difference between the stored fuel 624 and the stored oxidizer 626. The barrier 634 may be constructed of rubber, plastics, and/or various composite materials. In other implementations, the barrier is a relatively non-flexible structure (e.g., made of metal alloys, plastics, composites, etc.).

When it is desired that the fuel 624 and the oxidizer 626 be mixed, the barrier 634 is ruptured. If the fuel 624 is stored at a higher pressure than the oxidizer 626 (as depicted in FIG. 6), the fuel 624 primarily moves through the ruptured barrier 634 to mix with the oxidizer 626 (as illustrated by arrows 622). In another implementation when the oxidizer 626 is stored at a higher pressure than the fuel 624, the oxidizer 626 primarily moves through the ruptured barrier 634 to mix with the fuel 624. In various implementations, the oxidizer 626 and the fuel 624 move both directions through the ruptured barrier 634 to diffuse thoroughly together. Further, any additional movement of the fuel 624 and/or the oxidizer 626 causes an increased rate of mixing, as illustrated by circulation arrows (e.g., arrows 628). In one implementation, a separate mechanism (not shown) is used to induce movement of the fuel 624 and the oxidizer 626 and facilitate mixing.

In one implementation, a puncturing device (not shown) is used to selectively rupture the barrier 634. In another implementation, an explosive change 618 is selectively detonated to release sufficient energy to rupture the barrier 634 but insufficient energy to ignite the oxidizer 626 and the fuel 624. Other systems and methods for rupturing the barrier 634 without igniting the oxidizer 626 and the fuel 624 are contemplated herein.

Once the fuel 624 and the oxidizer 626 are adequately mixed as a single propellant, the propellant may be discharged from the storage tank 616 via an outlet 604 (as illustrated by arrows 632) with a control valve 608 that leads to a gas generator, a work-generating engine, or a device for generating thrust (not shown). In an example implementation utilizing an engine, the propellant flows from the outlet 604 of the storage tank 616, through the valve 608 (as illustrated by arrow 630), and into the engine, where work is extracted from the propellant. The control valve 608 may vary the flow rate of the propellant out of the storage tank 616 to provide a desired work output from the engine. In other implementations, the control valve 608 is used to provide a desired gas generation rate or a desired level of thrust from a thruster. In other implementations, the storage tank 616 stores two separate working fluids other than the fuel 624 and the oxidizer 626, which when combined may or may not produce a monopropellant.

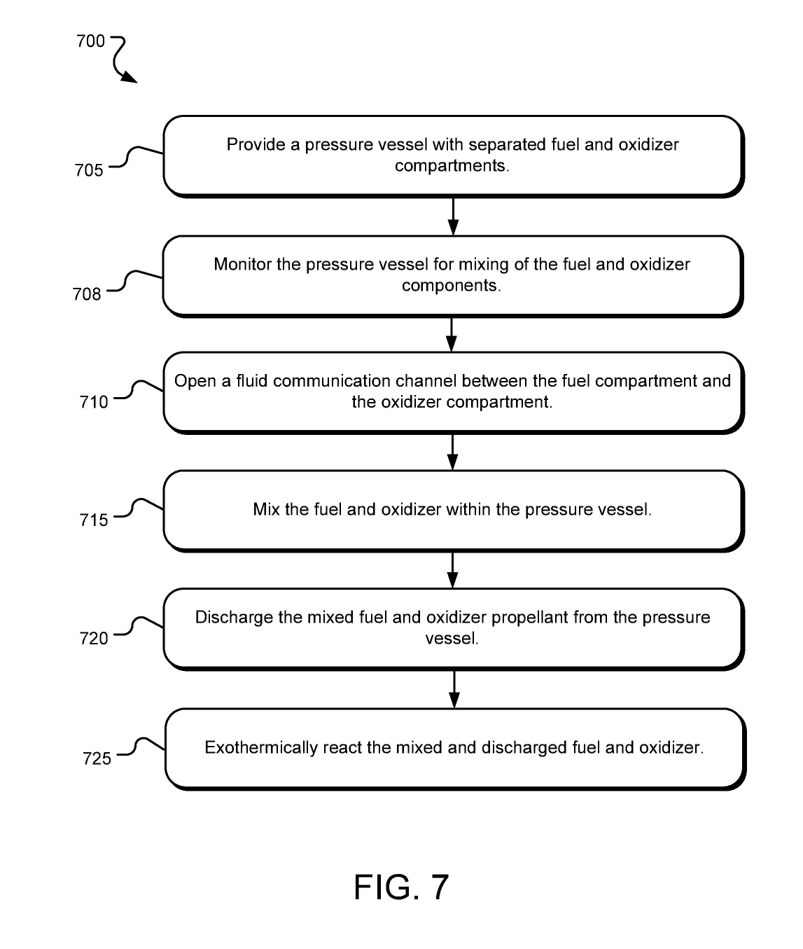

FIG. 7 illustrates example operations 700 for using an in-tank propellant mixing system. A providing operation 705 provides a pressure vessel with separated fuel and oxidizer compartments (or tanks). The separated fuel and oxidizer compartments provide some protection against inadvertent combustion of the stored fuel and oxidizer. The separated fuel and oxidizer compartments may be arranged in a variety of manners. For example, the fuel compartment may be one or more interior bladders or tanks stored with an outer oxidizer tank, or vice-versa. In a further example implementation, the fuel and oxidizer may be separated within a tank by a flexible membrane or rigid barrier. The interior tank, flexible membrane, or rigid barrier may be designed to withstand at least a pressure difference between the vapor pressure of the fuel and the oxidizer. In other implementations, the pressure vessel stores two separate working fluids other than the fuel and the oxidizer, which when combined may or may not produce a monopropellant. A monitoring operation 708 monitors the pressure vessel for mixing of the separated fuel and oxidizer components is incorporated within the providing operation 705. The monitoring operation 708 may also include alerting a user if the fuel and oxidizer components are inadvertently or unexpectedly mixed.

An opening operation 710 opens a fluid communication channel between the fuel compartment and the oxidizer compartment. The opening operation 710 may be accomplished by opening one or more valves on fluid lines connecting the fuel compartment and the oxidizer compartment, for example. Further, the opening operation 710 may be accomplished by rupturing the flexible membrane or rigid barrier separating the fuel compartment and the oxidizer compartment using a mechanical puncturing device or an explosive device, for example.

A mixing operation 715 mixes the fuel and oxidizer within the pressure vessel. In an example implementation where a long period of time is available for the fuel and oxidizer to mix, the fuel and oxidizer may mix via diffusion and/or convection without any mixing aids. In implementations where less time is available, mechanical or jetted agitation mechanisms may stir the fluid within the pressure vessel to expedite mixing of the fuel and the oxidizer. In various implementations, the time required or available for mixing can range from seconds to years. Further, a manifold with various shapes may distribute the fuel released into the oxidizer compartment or vice versa to expedite mixing of the fuel and the oxidizer.

Once the fuel and the oxidizer are mixed, the pressure vessel is at a greater risk of inadvertent combustion of the stored fuel and oxidizer. It may be desired to mix the fuel and oxidizer immediately prior in time to combustion of the mixed fuel and oxidizer propellant to minimize the risk of inadvertent combustion of the stored fuel and oxidizer.

A discharging operation 720 discharges the mixed fuel and oxidizer propellant from the pressure vessel. The mixed fuel and oxidizer propellant may be discharged to a gas generator, an engine that extracts work, or a rocket motor or thruster that generates thrust (all of which chemically react the mixed fuel and oxidizer). A reacting operation 725 exothermically reacts the discharged fuel and oxidizer in order to extract work or thrust from the reacting fuel and oxidizer. The reacting fuel and oxidizer may be combusting and/or decomposing, for example.

The logical operations making up the embodiments of the invention described herein are referred to variously as operations, steps, objects, or modules. Furthermore, not all described operations are required and additional operations may be performed, unless explicitly claimed otherwise or the claim language inherently necessitates a specific order.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A pressure vessel comprising:
a first working fluid compartment;
a second working fluid compartment; and
a mixing trigger that selectively triggers mixing of the first working fluid from the first working fluid compartment compartment with the second working fluid from the second working fluid compartment within the pressure vessel.

2. The pressure vessel of claim 1, wherein the second working fluid compartment is encompassed by the first working fluid compartment.

3. The pressure vessel of claim 2, wherein the second working fluid compartment includes a flexible bladder.

4. The pressure vessel of claim 1, wherein the second working fluid compartment is separated from the first working fluid compartment with a flexible membrane.

5. The pressure vessel of claim 1, wherein the mixing trigger includes a valve that selectively opens to trigger the mixing of the first working fluid with the second working fluid.

6. The pressure vessel of claim 1, wherein the mixing trigger includes a puncturing device that selectively punctures one or both of the first working fluid compartment and the second working fluid compartment to trigger the mixing of the first working fluid with the second working fluid.

7. The pressure vessel of claim 1, wherein the mixing trigger includes an explosive device that selectively ruptures one or both of the first working fluid compartment and the second working fluid compartment to trigger the mixing of the first working fluid with the second working fluid.

8. The pressure vessel of claim 1, wherein the mixing trigger includes a dissolvable portion of the second working fluid compartment that dissolves in one or both of the first working fluid and the second working fluid to trigger the mixing of the first working fluid with the second working fluid.

9. The pressure vessel of claim 1, further comprising:
a mixing monitor that monitors the pressure vessel for mixing of the first working fluid with the second working fluid.

10. The pressure vessel of claim 1, wherein the first working fluid includes an oxidizer, the second working fluid includes a fuel, and a mixture of the first working fluid and the second working fluid includes a monopropellant.

11. A method comprising:
providing a pressure vessel with a first working fluid compartment and a second working fluid compartment; and
selectively mixing the first working fluid from the first working fluid compartment with the second working fluid from the second working fluid compartment within the pressure vessel.

12. The method of claim 11, wherein the second working fluid compartment is encompassed by the first working fluid compartment.

13. The method of claim 12, wherein the second working fluid compartment includes a flexible bladder.

14. The method of claim 11, wherein the first working fluid compartment is separated from the second working fluid compartment with a flexible membrane.

15. The method of claim 11, wherein the selectively mixing operation includes opening a valve to trigger the mixing of the first working fluid with the second working fluid.

16. The method of claim 11, wherein the selectively mixing operation includes puncturing one or both of the first working fluid compartment and the second working fluid compartment to trigger the mixing of the first working fluid with the second working fluid.

17. The method of claim 11, wherein the selectively mixing operation includes igniting an explosive device to rupture one or both of the first working fluid compartment and the second working fluid compartment and trigger the mixing of the first working fluid with the second working fluid.

18. The method of claim 11, wherein the selectively mixing operation includes dissolving a portion of the second working fluid compartment in one or both of the first working fluid and the second working fluid to trigger the mixing of the first working fluid with the second working fluid.

19. The method of claim 11, further comprising:
monitoring the pressure vessel for mixing of the first working fluid with the second working fluid.

20. The method of claim 11, wherein the first working fluid includes an oxidizer, the second working fluid includes a fuel, and a mixture of the first working fluid and the second working fluid includes a monopropellant.

21. A method comprising:
selectively mixing fuel with oxidizer within a pressure vessel;
discharging the mixed fuel and oxidizer from the pressure vessel; and
exothermically reacting the mixed and discharged fuel and oxidizer.

22. The method of claim 19, wherein one or both of work and thrust are extracted from the exothermically reacting fuel and oxidizer.
